(19) United States
(12) Patent Application Publication
(10) Pub. No.: US 2025/0084852 A1
(43) Pub. Date: Mar. 13, 2025

(54) POOL COVER PUMP

(71) Applicant: Joseph R. Pinto, Scottsdale, AZ (US)

(72) Inventor: Joseph R. Pinto, Scottsdale, AZ (US)

(21) Appl. No.: 18/596,466

(22) Filed: Mar. 5, 2024

Related U.S. Application Data
(60) Provisional application No. 63/581,765, filed on Sep. 11, 2023.

(51) Int. Cl. F04D 15/00; F04D 29/58

(52) U.S. Cl. CPC F04D 15/0077; F04D 29/588; F05D 2270/303

(57) ABSTRACT

One example pool cover pump is configured to prevent ice from forming at the pool cover pump. The pool cover pump may include a housing with a plurality of openings to allow water to flow through and a pump motor. The pool cover pump can also include a heating element configured to heat an area within or near the housing to prevent ice formation. The device can also include a sensor to sense a temperature. The device can also include a controller located within the housing communicate with the sensor, determine that the temperature is below a threshold, and activate the heating element to prevent ice from forming within or near the pool cover pump.

### BACKGROUND

Pool cover pumps are typically used to pump water off the top of outdoor swimming pool covers, safety covers, safety pool covers, etc. However, varying weather conditions and seasonal temperatures may impact the performance and usability of pool cover pumps. For example, accumulation of snow or ice atop the cover may prevent a pool cover pump from draining water efficiently. In another example, pool cover pumps may be damaged by ice formation within the pump if left out in in inclement weather conditions.

### SUMMARY

Various embodiments described herein relate to systems, devices, and methods for preventing ice from forming at a swimming pool cover pump. Embodiments of the present disclosure relate to a method of preventing ice from forming at a pool cover pump, comprising: providing a pool cover pump, the pool cover pump comprising: a housing; and a pump motor coupled to the housing, wherein the housing comprises: a plurality of input openings configured to allow water to flow through the plurality of input openings and into the pump motor, and a heating element located within the housing and configured to heat an area located proximate to the housing; sensing a temperature with a sensor coupled to the housing; determining the temperature is below a temperature threshold; and activating the heating element to prevent ice from forming at the area located proximate to the housing.

In some embodiments, method further comprises: determining that the temperature exceeds a second threshold; and deactivating the heating element.

In some embodiments, the heating element comprises a heating cable, wherein the heating cable comprises insulated resistive heating wires.

In some embodiments, the heating cable extends radially from a center of a bottom interior surface of the housing between at least two of the plurality of input openings.

In some embodiments, the heating cable extends in a spiral pattern from a center of a bottom interior surface of the housing between at least two of the plurality of input openings.

In some embodiments, the temperature includes a local temperature or an ambient temperature.

In some embodiments, the heating element wraps around a passageway of the pump motor and an output port coupled to the housing.

Embodiments of the present disclosure relate to an apparatus, comprising: a housing, wherein the housing comprises a plurality of input openings configured to allow water to flow through the plurality of input openings; a pump motor located within the housing; a heating element located within the housing and configured to heat an area located proximate to the housing; a sensor coupled to the housing; a controller located within the housing, wherein the controller is configured to: sense a temperature; determine the temperature is below a temperature threshold; and activate the heating element to prevent ice from forming at the area proximate to the housing.

In some embodiments, the controller is further configured to: determine that the temperature exceeds a second threshold; and deactivate the heating element.

In some embodiments, the heating element comprises a heating cable, wherein the heating cable comprises insulated resistive heating wires.

In some embodiments, the heating cable extends radially from a center of a bottom interior surface of the housing between at least two of the plurality of input openings.

In some embodiments, the heating cable extends in a spiral pattern from a center of a bottom interior surface of the housing between at least two of the plurality of input openings.

In some embodiments, the temperature includes a local temperature or an ambient temperature.

In some embodiments, the heating element extends to wrap around a passageway of the pump motor and an output port coupled to the housing.

Embodiments of the present disclosure relate to an apparatus, comprising: a housing, wherein the housing comprises a plurality of input openings configured to allow water to flow through the plurality of input openings; a pump motor located within the housing; a heating element located along a passageway of the pump motor to an output port and configured to heat an area within the passageway of the pump motor and the output port; a sensor coupled to the housing; a controller located within the housing, wherein the controller is configured to: sense a temperature; determine the temperature is below a temperature threshold; and activate the heating element to prevent ice from forming at the area located within the passageway of the pump motor.

In some embodiments, the controller is further configured to: determine that the temperature exceeds a second threshold; and deactivate the heating element.

In some embodiments, the heating element comprises a heating cable. In some embodiments, the heating cable encircles a base of the pump motor. In some embodiments, the heating cable encircles the output port. In some embodiments, the heating cable comprises insulated resistive heating wires.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 illustrates an example pool cover pump for preventing ice from forming.

FIG. 2A illustrates an example pool cover pump with an open bottom configuration.

FIG. 2B illustrates an example detachable base component.

FIGS. 3A-3D illustrate example heating element configurations for a pool cover pump, such as the pool cover pump of FIG. 1.

FIG. 4A-4B illustrates an example pool cover pump with a coupled external heating element.

FIG. 5 illustrates an example controller within a housing of a pool cover pump, such as the pool cover pump of FIG. 1.

FIG. 6 illustrates an example flow diagram depicting a process for preventing ice from forming at a pool cover pump.

### DETAILED DESCRIPTION

Pool cover pumps may be placed atop outdoor swimming pool covers (also known as safety covers, safety pool covers, etc.) to help drain excess water from collecting on the surface of the cover. Because of changing ambient temperatures and varying weather conditions, it would be advantageous to provide a pool cover pump that can continue to pump water in various environmental conditions.

Examples described herein provide a pool cover pump apparatus to preventing ice formation by integrating a heating element within the housing of the pool cover pump. A heating element located within the pool cover pump, such as proximate to input openings at the bottom of the pump, prevent surrounding water from freezing in cold weather. Other configurations of the heating element within the pool cover pump may advantageously allow the pump to work in a variety of weather conditions.

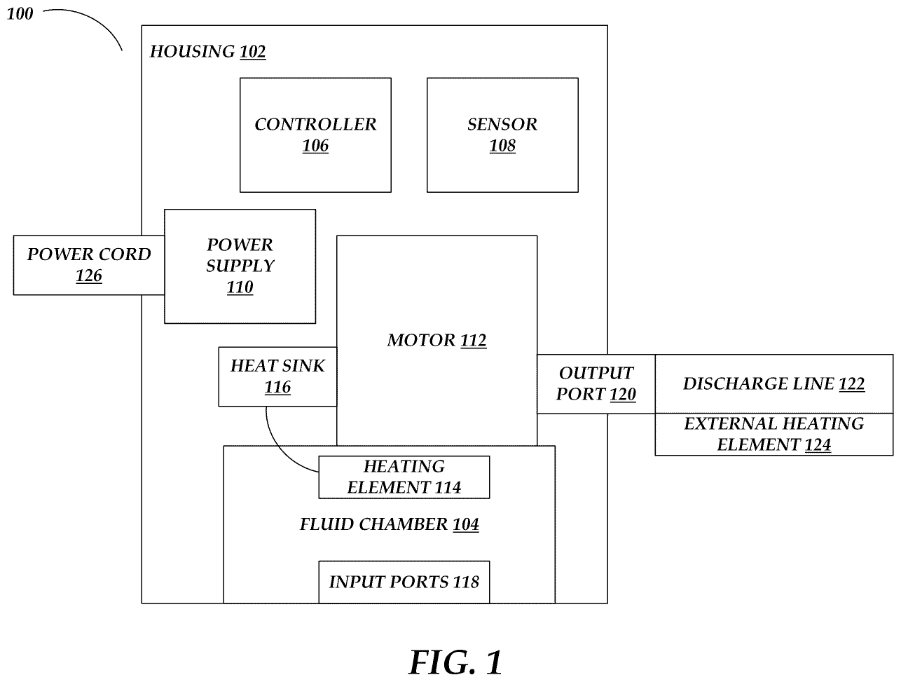

FIG. 1 illustrates an example pool cover pump (“pump”) 100 for preventing ice from forming at the pool cover pump. In some examples, pump 100 includes a variety of components within housing 102. For example, as illustrated in FIG. 1, housing 102 includes fluid chamber 104, controller 106, sensor 108, power supply 110, pump motor (“motor”) 112, heating element 114, heat sink 116, input ports 118, and output port 120. Pump 100 may also include power cord 126 connected to power supply 110.

In some examples, pump 100 may be partially or fully submerged in water. As such, in some examples, pump 100 may intake water to the fluid chamber 104 through input ports 118. In some examples, input ports 118 may be any openings in the housing 102 configured to let water flow into the fluid chamber 104. For example, input ports 118 may include input openings, channels, holes, punctures, mesh, etc. In some examples, input ports 118 may be located at or proximate to a bottom portion of the housing 102.

In an alternative embodiment, pump 100 may include a detachable base component (stabilizer) such that there is no bottom surface of the housing (“open bottom” configuration). In some embodiments, the detachable base component is conical in shape without a bottom surface. In some embodiments, the detachable base component may snap, clip, or otherwise be secured to the pump 100. In some embodiments, the detachable base may be connected to the pump 100 such that the pump 100 is suspended off a surface of a pool cover, and such that only the sides of the detachable base component make contact with the surface of the pool cover. In some embodiments, the detachable base component may form the fluid chamber 104 below the pump 100. For example, the detachable base component may include input ports 118 on the top and/or sides such that water may flow into the fluid chamber.

As shown in FIG. 1, motor 112 may be coupled to the fluid chamber 104. In some examples, motor 112 may be configured to pump, suction, or otherwise expel water from the fluid chamber 104 out through the output port 120. In some examples, motor 112 may include internal components such as an impeller, an inlet, a volute, etc. In some examples, motor 112 may rotate an impeller on a shaft to remove water by pumping it out through an output port 120 to a connected hose, etc.

In some examples, output port 120 may be connected to a discharge line 122. The discharge line 122 may include a hose, pipe, tube, duct, line, outlet, etc. configured to transport the pumped water away from the pump 100.

In some examples, heating element 114 may any component configured to heat a surrounding area, for example, the water near or within the fluid chamber 104. For example, heating element 114 may utilize various heating methods, such as electrical, induction, ceramic, convection, thermal fluid, etc. In some examples, heating element 114 may be in any form, including cables, resistive wires, coils, tapes, bands, etc. In some examples, heating element 114 may be coupled to the power supply 110 and may be configured to receive and convert electrical energy to heat energy. In some embodiments, the power supply 110 may be spliced between the motor 112, sensor 108, and the heating element 114. In some examples, heating element 114 may be coupled to the heat sink 116 and may be configured to receive heat energy from the heat sink 116 instead of, or in addition to, converting electrical energy into heat.

In some examples, heating element 114 may be positioned in various locations on or within the housing 102. In some examples, heating element 114 may be located within the fluid chamber 104. For example, heating element 114 may be located along a bottom interior surface of the housing within the fluid chamber. In some examples, heating element may be located proximate to input ports 118 to heat water as it enters the fluid chamber 104. In some examples, In some examples, heating element may be located along various passageways within housing 102. For example, heating element 114 may encircle a base of the motor 112 or output port 120 to prevent water from freezing within these components. In some examples, heating element 114 may be arranged in a specific shape or configuration within the fluid chamber. For example, a cable or wire-type heating element 114 may be arranged radially from a center of the bottom interior surface of the housing. In other examples, the heating element 114 may arranged in a spiral pattern from the center of the interior surface of the housing. Other configurations/shapes of cable-type heating element 114 are possible, such as zigzag, triangular, circular, rectangular, etc.

In some embodiments, such as an open-bottom configuration pump, the heating element 114 may be located on a top interior surface of the detachable base component. In some embodiments, heating element 114 may be suspended within the fluid chamber such that the heating element 114 does not make contact with a surface of the fluid chamber, the detachable base component, and/or the pool cover.

In some examples, heating element 114 may receive current from a power supply 110. In some examples, the current level provided to heating element 114 may vary depending on a sensed temperature from sensor 108. For example, if the sensed temperature is “low” (e.g., below freezing, far below freezing), such as 32 to 34 degrees Fahrenheit, for example, the current provided to heating element 114 may be increased, or at a level higher than if the sensed temperature is “high” (e.g., not close to freezing). In some examples, current level provided to the heating element 114 may be a range of current levels.

The pump 100 may also be configured to prevent ice formation in the discharge line 122 as water is being transported away from the pump. For example, the heating element 114 may include a heating element that is external to the pump 100, such as external heating element 124. The external heating element 124 may include a cable, wire, coil, or any other flexible element configured to make contact with the discharge line 122 and prevent ice formation within the discharge line 122.

As shown in FIG. 1, the external heating element 124 may be located outside the pump 100 and proximate to the discharge line 122. The external heating element 124 may be in the form of a cable, wire, or coil, such as an insulated resistive heating wire. In some examples, the external heating element 124 may consist of a single insulated resistive heating wire. In some examples, the external heating element 124 may consist of multiple elements, such as multiple insulated resistive heating wires.

The external heating element 124 may be wrapped around the discharge line 122, such as in a coil-type configuration. In some embodiments, the external heating element 124 may include a wire or other pliable-type material that allows the external heating element 502 to conform to the shape of the discharge line 122. In some embodiments, the external heating element 124 includes attachments configured to secure the external heating element 124 to the discharge line 122. For example, attachments may include hook and loop fasteners, straps, clamps, snaps, wires, clasps, sleeves, bands, and the like. The external heating element 124 may be pre-coiled in some examples, to allow easy attachment to the discharge line 122.

In some examples, external heating element 124 may be coupled to the power supply 110 and may be configured to receive and convert electrical energy to heat energy. In some embodiments, the power supply 110 may be spliced between the motor 112, sensor 108, the heating element 114, and the external heating element 124. In some examples, the external heating element 124 may be coupled to the heat sink 116 and/or the heating element 114 and may be configured to receive heat energy from the heat sink 116 instead of, or in addition to, converting electrical energy into heat.

Alternatively, or in addition, the external heating element 124 may be detachable from or pluggable into the pump 100. In some examples, the external heating element 124 may include a switch that provides separate functionality from the heating element 114. For example, although the external heating element 124 may be attached to the pump 100, a user may separately control the functionality of the heating element 114 and the external heating element 124. In addition, the external heating element 124 may be controlled wirelessly by a separate device. It is noted that all functionality described herein with respect to the heating element 114 may also be applied to the external heating element 124.

In some examples, motor 112 may be connected to heat sink 116. In some examples, heat sink 116 may be any component that increases heat flow away from a device (e.g., electrical, or mechanical), such as motor 112. In some examples, heat sink 116 may be made of any material configured to exchange heat, such as aluminum, copper, or any other heat-transferring material. In some examples, heat sink 116 may transfer heat away from motor 112 into a different fluid medium, such as air or a liquid coolant. In some examples, heat sink 116 may be coupled to other components within pump 100, such as heating element 114. In some examples, heat sink 116 may transfer heat away from motor 112 to heating element 114. In some examples, heat transferred from heat sink 116 to heating element 114 may aid in preventing ice formation within the fluid chamber 104.

In some examples, water pumped by motor 112 may flow through output port 120. In some examples, output port 120 may include a channel, a valve, an opening, etc. In some examples, output port 120 may be connected to a hose, pipe, tube, duct, line, outlet, etc. configured to transport the pumped water away from the pump 100. In some examples, output port 120 may be connected to a hose, pipe, tube, duct, line, outlet, etc. configured to transport pumped water away from a pool cover.

In some examples, pump 100 may include a sensor 108. For example, sensor 108 may include a thermostat, a thermometer, a thermistor, or any other instrument configured to measure a temperature. In some examples, sensor 108 may be configured to measure a local temperature at a location within the pump 100. In some examples, sensor 108 may be located at a location proximate to the pump 100. For example, sensor 108 may be located within the housing 102 of pump 100 proximate to the fluid chamber 104 to measure a temperature of water in the fluid chamber 104. In some examples, sensor 108 may be located anywhere within, atop, or proximate the housing 102 and may be used to measure an ambient temperature. In some examples, sensor 108 may be send a signal to controller 106 containing information relating to a measured temperature. In some examples, pump 100 may include multiple sensors placed at various location within pump 100. In some examples, multiple sensors 108 may be send signals to controller 106 containing information relating to a measured temperature from multiple sensors.

In some examples, sensor 108 may also include a sensor coupled to the heating element 114 to measure a temperature of the heating element 114. In some examples, sensor 108 coupled to the heating element 114 may send information relating to the temperature of the heating element 114 to the controller 106.

In some examples, controller 106 may receive and send signals to and from various components within pump 100. In some examples, controller 106 may control the operations of various components within pump 100. In some examples, controller 106 may control operations of the heating element 114 in response to received temperature information from the sensor 108. For example, if the received temperature information from the sensor 108 indicates an ambient temperature of below freezing, the controller 106 may send an “on” signal to the heating element 114. In another example, controller 106 may control operations of the motor 112, such as to prevent damage to the pump 100, by shutting off the motor 112 when an ambient or local temperature drops far below freezing.

In some examples, power supply 110 may be within housing 102. Power supply 110 may be configured to supply power to various components of pump 100 via power cord 126.

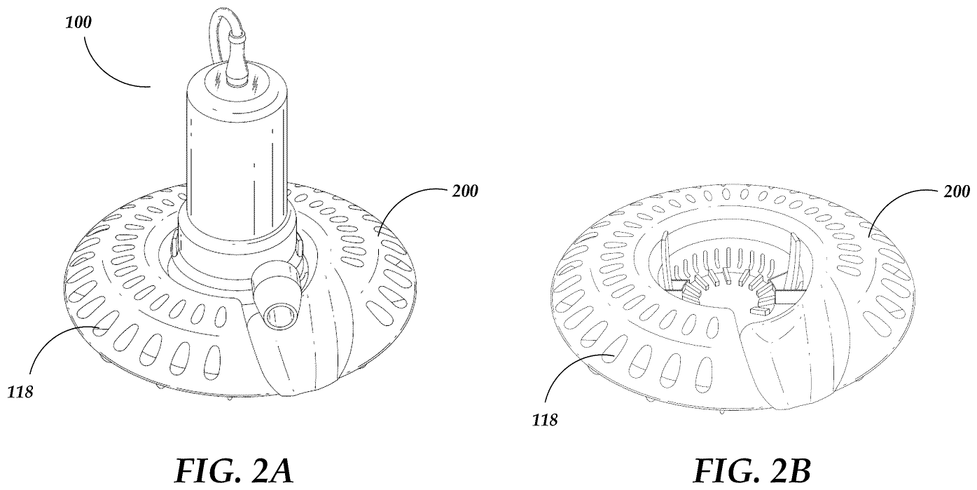

FIG. 2A illustrates an example pump 100 with an open-bottom configuration. As described above, pump 100 may include a detachable base component (stabilizer) 200 such that there is no bottom surface of the housing. FIG. 2A illustrates an example configuration of a pump with a detachable base component. As shown, the detachable base component 200 is conical or dome-shaped with input ports 118 on the sides/top.

FIG. 2B illustrates an example detachable base component 200 separated from the pump 100. In some embodiments, the detachable base component may snap, clip, or otherwise be secured to the pump 100. In some embodiments, the detachable base may be connected to the pump 100 such that the pump 100 is suspended off a surface of a pool cover, and such that only the sides of the detachable base component make contact with the surface of the pool cover. In some embodiments, the detachable base component may form the fluid chamber 104 below the pump 100. For example, the detachable base component may include input ports 118 on the top and/or sides such that water may flow into the fluid chamber.

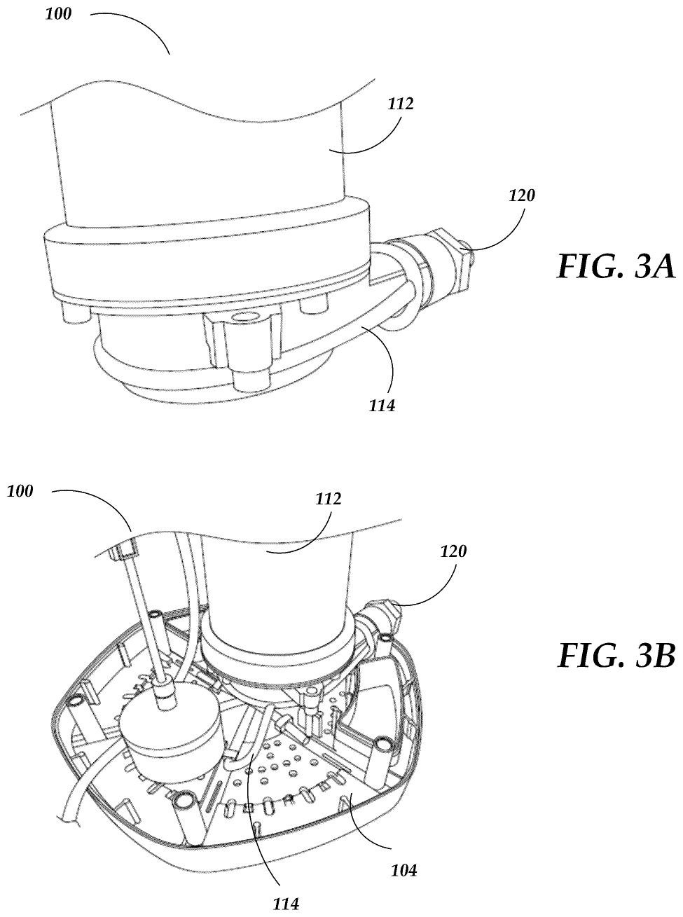

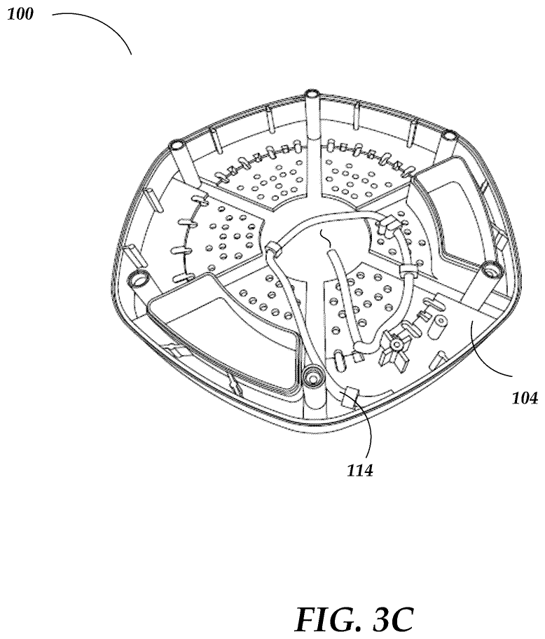

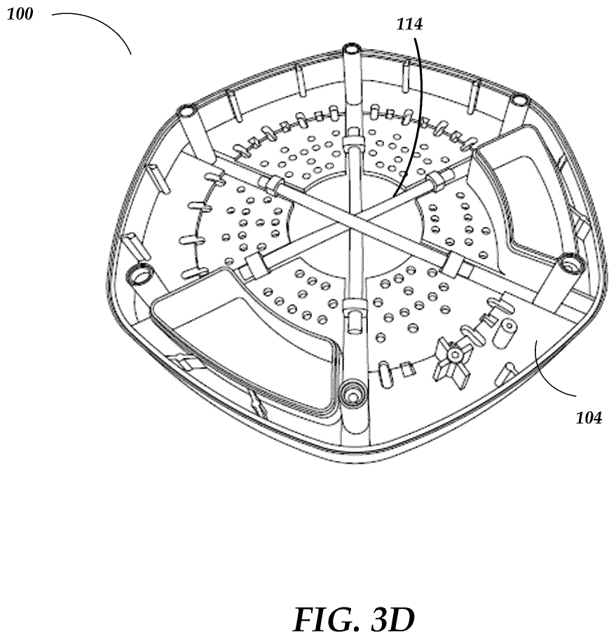

FIGS. 3A-3D illustrate example heating element configurations for a pool cover pump, such as the pool cover pump of FIG. 1.

FIG. 3A illustrates an example heating element configuration in which the heating element 114 is located proximate to the motor 112. As illustrated, pump 100 may contain motor 112 and output port 120. As illustrated, heating element 114 may be in the form of a cable or wire-type heating element, such as an insulated resistive heating wire. In some examples, heating element 114 may be wrapped around a base of the motor 112 to prevent ice formation within the fluid chamber 104 at, in, or near the motor 112, such as when pump 100 is submerged in water. In some examples, heating element 114 may also be wrapped around the output port 120, as shown. In some examples, heating element 114 may be configured to prevent ice formation at, in, or near the output port 120. It may be advantageous to prevent ice formation either within or near the motor 112 to prevent damage to the motor 112, output port 120, or pump 100 overall. In some examples, heating element 114 may consist of a single insulated resistive heating wire. In some examples, heating element 114 may consist of multiple elements, such as multiple insulated resistive heating wires.

Although not pictured in FIG. 3A, heating element 114 may be connected to the power supply 110. As noted above, in some embodiments, the power supply 110 may be spliced between the motor 112, sensor 108, and the heating element 114. In some embodiments, insulated wires may be used to connect current from the power supply 110 to the heating element 114.

FIG. 3B illustrates an additional heating element configuration in which the heating element 114 is located proximate to the motor 112 and at a bottom interior surface of the fluid chamber 104. As illustrated, heating element 114 may wrap around various elements of the pump 100, such as the motor 112 or output port 120, and may also be located at various locations within the fluid chamber 104. In some examples, heating element 114 may consist of a single insulated resistive heating wire. In some examples, heating element 114 may consist of multiple elements, such as multiple insulated resistive heating wires.

FIG. 3C illustrates an additional heating element configuration in which the heating element 114 is located on the bottom interior surface of the fluid chamber 104 in a spiral pattern. As shown, in some embodiments, heating element 114 may consist of insulated resistive heating wire. In some embodiments, the heating element may be located on the bottom interior surface of the fluid chamber 104. For example, the heating element 114 may be located proximately below the motor 112, as shown in FIG. 3C as a spiral covering a portion of the bottom surface. In some embodiments, heating element 114 may cover the entire bottom interior surface. For example, heating element 114 may extend to the outer edges of the bottom interior surface. In some embodiments, heating element 114 may be arranged so as to not block input ports 118 and/or other channels.

FIG. 3D illustrates an additional heating element configuration in which the heating element 114 is located on the bottom interior surface of the fluid chamber 104 in an asterisk or radial pattern. It is noted that FIG. 3D is meant to illustrate an example configuration of the heating element 114 in an alternative, non-limiting arrangement. As shown, in some embodiments, heating element 114 may comprise multiple insulated resistive heating wires. Although not pictured, in other embodiments, heating element 114 may comprise a single insulated resistive heating wire arranged in a radial or asterisk pattern. For example, although not pictured, the multiple insulated resistive wires may be connected such that a single wire is formed. In some embodiments, heating element 114 may cover the entire bottom interior surface. In some embodiments, heating element 114 may be arranged so as to not block input ports 118 and/or other channels.

Although FIGS. 3C and 3D illustrate two heating element configurations, heating element 114 may be arranged in any other configuration on the bottom interior surface of the fluid chamber 104. In other embodiments, heating element 114 is located at any other location within the fluid chamber 104, such as on the sides, suspended within the fluid chamber 104, etc. In some elements, heating element 114 is located at various locations at or around the pump 100, such as on an exterior of the pump 100 or housing 102, within the walls of the fluid chamber 104, within the walls of the housing 102, etc.

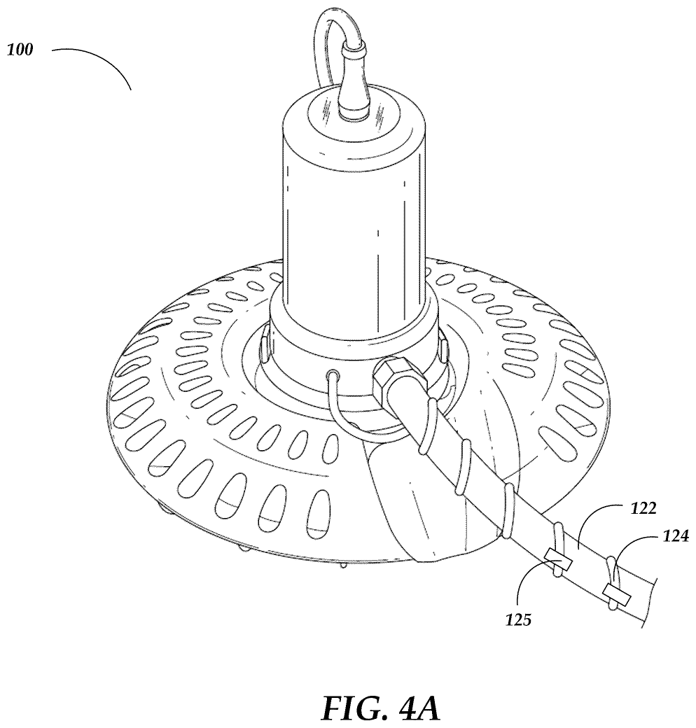

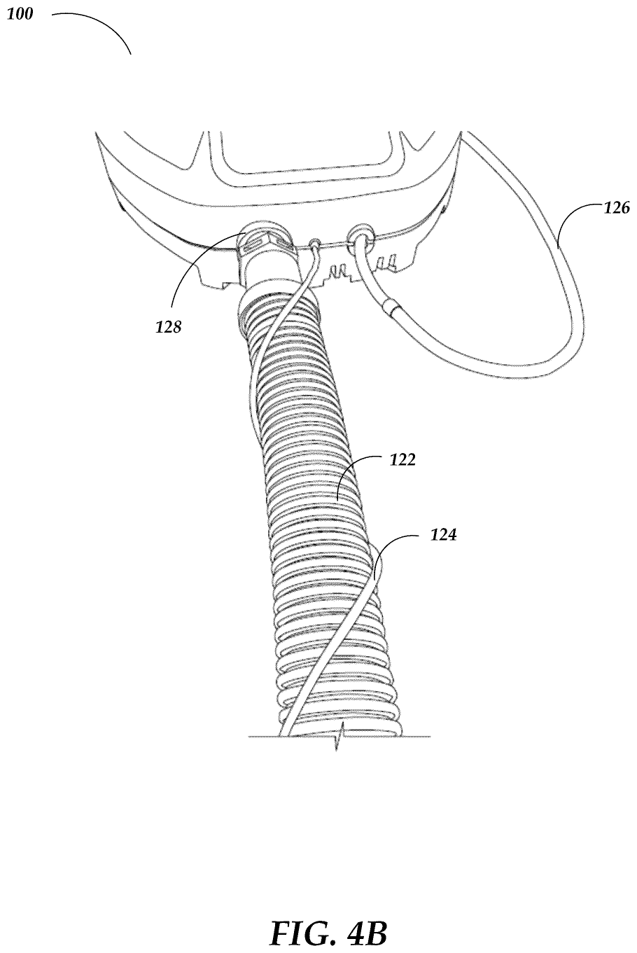

FIGS. 4A and 4B illustrate an example pool cover pump 100 with a coupled external heating element 124. The external heating element 124 may be located proximate to the discharge line 122. As described herein, the discharge line 122 may include a hose, pipe, tube, duct, line, outlet, etc. configured to transport the pumped water away from the pump 100. The discharge line 122 may be screwed, fitted, or otherwise secured to the output port 120 of the pump 100 to allow water to flow out away from the pump 100.

Also as described herein, the external heating element 124 may be located outside the pump 100 and proximate to the discharge line 122. The external heating element 124 may be in the form of a cable, wire, or coil, such as an insulated resistive heating wire. In some examples, the external heating element 124 may consist of a single insulated resistive heating wire. Although not pictured in FIG. 4, the external heating element 124 may consist of multiple elements, such as multiple insulated resistive heating wires. the external heating element 124 may be wrapped around the discharge line 122, such as in a coil-type configuration. In some examples, the external heating element may extend along the discharge line 122 in a linear configuration, or any other configuration that prevents ice formation within the discharge line 122. In some embodiments, the external heating element 124 may include a wire or other pliable-type material that allows the external heating element 502 to conform to the shape of the discharge line 122.

Alternatively, or in addition, the external heating element 124 may be detachable from or pluggable into the pump 100. For example, the external heating element 124 may be in the form of a cable that can plug into a port on a base or a side of the pump 100, as shown in FIG. 4. As shown in FIG. 4B, the external heating element 124 may connect to the pump 100 via connector 128. The connector 128 may be an opening within the pump 100 to allow the external heating element 124 to be coupled to the pump 100. In some embodiments, the external heating element 124 may be hardwired to the pump 100 via the connector 128 such that the external heating element 124 is not detachable. In some embodiments, the external heating element 124 may snap, twist, or otherwise attach to the pump 100 via the connector 128 opening within the pump 100.

In some embodiments, the external heating element 124 includes attachments 125 configured to secure the external heating element 124 to the discharge line 122. For example, attachments 125 may include hook and loop fasteners, straps, clamps, snaps, wires, clasps, sleeves, bands, and the like. The external heating element 124 may be pre-coiled in some examples, to allow easy attachment to the discharge line 122.

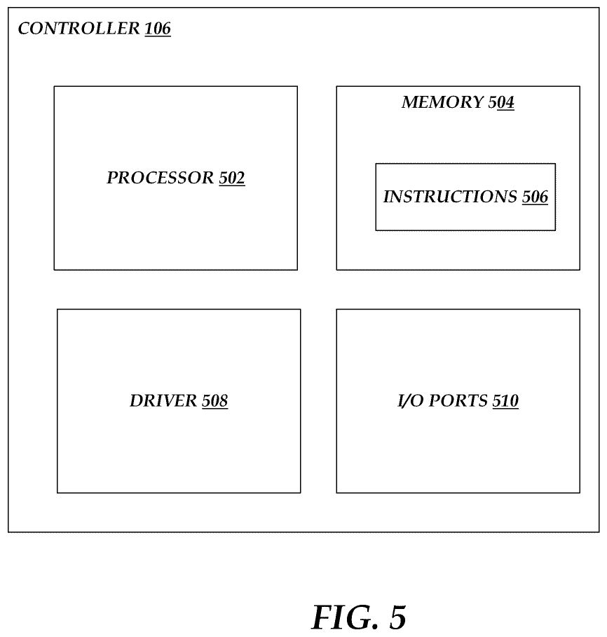

FIG. 5 illustrates an example controller 106 within a housing 102 of a pool cover pump, such as the pool cover pump of FIG. 1. As shown, in some examples, controller 106 includes processor 502, memory 504 and instructions within memory 504, driver 508, and input/output (“I/O”) ports 510. In some examples, processor 502 may be configured to execute instructions 506 stored in memory 504 relating to controlling various components of pump 100.

As an example, processor 502 may be configured to control operation of the heating element 114 in order to prevent ice formation proximate to the pump 100. For example, processor 502 may receive information relating to a temperature from sensor 108. In some examples, processor 502 may determine whether the temperature is below a temperature threshold (ex. freezing point of water). In that example, if the temperature is determined to be below the temperature threshold, the processor may send a signal to the driver 508 to activate or deactivate the heating element 114. In some examples, processor 502 may, based on the sensed temperature, send a signal through driver 508 to control the current level(s) to heating element 114.

In some examples, driver 508 may be coupled to the motor 112 and configured to control operations of the motor 112. In some examples, driver 508 may receive a signal from the processor 502 to start or stop operations of the motor 112. In another example, controller 106 may control operations of the motor 112 via driver 508, such as to prevent damage to the pump 100, by shutting off the motor 112 when an ambient or local temperature drops far below freezing. In some examples, controller 106 may control operations of the heating element 114 via driver 508 in response to received temperature information from the sensor 108. For example, if the received temperature information from the sensor 108 indicates an ambient temperature of below freezing, the controller 106 may send an “on” signal through the driver 508 to the heating element 114. In another example, if the received temperature information from the sensor 108 indicates a local temperature near the fluid chamber 104 of below freezing, the controller 106 may send an “on” signal through the driver 508 to the heating element 114.

In some examples, I/O ports 510 may be configured to receive and send signals between other components of pump 100. For example, sensor 108 may be connected to the controller 106 via I/O ports 510 and further configured to send signals to the controller 106 via I/O ports 510.

In some examples, the pump 100 may be configured to communicate wirelessly with a device. For example, the device may be any device capable of connecting to and communicating with the pump 100 and may include personal computing devices, laptop computing devices, tablet computing devices, electronic reader devices, wearable computing devices, mobile devices (e.g., cellular, and other mobile phones, smart phones, media players, handheld gaming devices, etc.), streaming media devices, and various other electronic devices and appliances. In some examples, pump 100 may be connected to a device using a wired connection. Connections are not limited to wired connections but may instead work through wireless communication such as BLUETOOTH®, Wi-Fi®, according to an IEEE 802 standard, etc.

In an example, processor 502 may receive and send signals, such as messages, to and from a connected device, such as directly, or over a network. For example, processor 502 may receive information from sensor 108 indicating that a temperature has dropped below a certain threshold. The processor 502 may send a signal, such as a push notification, to the connected device, either directly or via a server. In some examples, the push notification may indicate that a sensed temperature has dropped below a certain threshold, that a sensed temperature has risen above certain threshold, or that ice formation may occur, etc. In some examples, the push notification may prompt a user to turn off/on the heating element. In some examples, processor 502 may receive a signal from the connected device indicating a response to a push notification. In response to a push notification response, the processor 502 may control operations of various components of the pump 100, such as turning on/off the heating element 114, motor 112, or pump 100. In some examples, a user may indicate a desired duration to keep the heating element 114 on, such as 30 minutes, 1 hour, 2 hours, etc. In that example, processor 502 may receive this information from the device and control operations of the pump 100 accordingly.

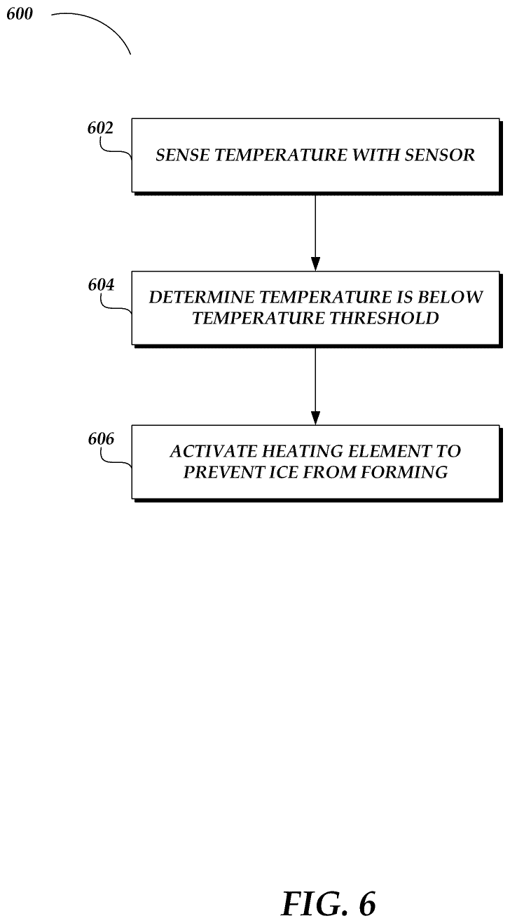

FIG. 6 illustrates an example flow diagram depicting a process for preventing ice from forming at a pool cover pump. Routine 600 may be implemented by a processor of the pool cover pump, such as processor 502. In some examples, the pool cover pump of routine 600 may comprise a housing and a pump motor, the housing comprising a plurality of input openings configured to allow water to flow through the plurality of input openings and into the pump motor. In some examples, the housing of the pool cover pump of routine 600 further comprises a heating element located along a bottom interior surface of the housing between each of the plurality of input openings and configured to heat an area located below a bottom surface of the housing.

At block 602, the processor senses a temperature with a sensor coupled to a housing of a pump.

At block 604, the processor determines the temperature is below a temperature threshold.

At block 606, the processor activates the heating element to prevent ice from forming. In some examples, the processor activates the heating element to prevent ice from forming at the area located below the bottom surface of the housing.

In some examples, the heating element comprises a heating cable. In some examples, the heating cable extends radially from a center of the bottom interior surface of the housing between the plurality of input openings. In some examples, the heating cable extends in a spiral pattern from a center of the bottom interior surface of the housing between the plurality of input openings. In some examples, the heating cable comprises insulated resistive heating wires. In some examples, the heating element extends to wrap around a passageway of the pump motor and an output port.

In some examples, the processor can be further configured to determine that the temperature exceeds a second threshold. In some examples, the processor can be further configured to deactivate the heating element.

Various example embodiments of the disclosure can be described by the following clauses:

Clause 1. A method of preventing ice from forming at a pool cover pump system, the method comprising: providing a pool cover pump, the pool cover pump comprising: a housing; a pump motor coupled to the housing configured to pump water;
a discharge line external to the housing and configured to transport water away from the pump motor; an internal heating element located within the housing; and an external heating element located proximate to the discharge line; sensing a first temperature with a sensor coupled to the housing and a second temperature with a second sensor coupled to the discharge line; determining that the first temperature is below a first threshold and that the second temperature is below a second threshold; and activating the internal heating element to prevent ice formatting at an area proximate to the housing and activating the external heating element to prevent ice from forming at an area proximate to the discharge line.

Clause 2. The method of clause 1, further comprising: determining that the first temperature exceeds a third threshold; and deactivating the internal heating element.

Clause 3. The method of clause 1, further comprising: determining that the second temperature exceeds a fourth threshold; and deactivating the external heating element.

Clause 4. The method of clause 1, wherein the external heating element comprises a heating cable, wherein the heating cable comprises insulated resistive heating wires.

Clause 5. The method of clause 1, wherein the external heating element is coiled, wrapped, entwined, or looped around the discharge line.

Clause 6. The method of clause 1, wherein the external heating element is coupled to the discharge line using hook and loop fasteners, straps, clamps, snaps, wires, clasps, sleeves, or bands.

Clause 7. The method of clause 1, wherein the first temperature and the second temperature include a local temperature or an ambient temperature.

Clause 8. An apparatus, comprising: a housing; a pump motor coupled to the housing configured to pump water; a discharge line external to the housing and configured to transport water away from the pump motor; an internal heating element located within the housing; and an external heating element located proximate to the discharge line; a first sensor coupled to the housing; a second sensor coupled to the discharge line; a controller located within the housing, wherein the controller is configured to: sense a first temperature with the first sensor and a second temperature with the second sensor; determine that the first temperature is below a first threshold and that the second temperature is below a second threshold; and activate the internal heating element to prevent ice formatting at an area proximate to the housing and activate the external heating element to prevent ice from forming at an area proximate to the discharge line.

Clause 9. The apparatus of clause 8, wherein the controller is further to: determine that the first temperature exceeds a third threshold; and deactivate the internal heating element.

Clause 10. The apparatus of clause 8, wherein the controller is further to: determine that the second temperature exceeds a fourth threshold; and deactivate the external heating element.

Clause 11. The apparatus of clause 8, wherein the external heating element comprises a heating cable, wherein the heating cable comprises insulated resistive heating wires.

Clause 12. The apparatus of clause 8, wherein the external heating element is coiled, wrapped, entwined, or looped around the discharge line.

Clause 13. The apparatus of clause 8, wherein the external heating element is coupled to the discharge line using hook and loop fasteners, straps, clamps, snaps, wires, clasps, sleeves, or bands.

Clause 14. The apparatus of clause 8, wherein the first temperature and the second temperature include a local temperature or an ambient temperature.

Clause 15. An apparatus, comprising: a housing; a pump motor coupled to the housing configured to pump water; a discharge line external to the housing and configured to transport water away from the pump motor; an external heating element located along a length of the discharge line and configured to heat an area within a passageway of the discharge line; a sensor coupled to the discharge line; a controller to: sense a temperature with the sensor; determine the temperature is below a first threshold; activate the external heating element to prevent ice from forming at an area within the passageway of the discharge line.

Clause 16. The apparatus of clause 15, wherein the controller is further to: determine that the temperature exceeds a second threshold; and deactivate the external heating element.

Clause 17. The apparatus of clause 15, wherein the external heating element comprises a heating cable, wherein the heating cable comprises insulated resistive heating wires.

Clause 18. The apparatus of clause 15, wherein the external heating element is coiled, wrapped, entwined, or looped around the discharge line.

Clause 19. The apparatus of clause 15, wherein the external heating element is coupled to the discharge line using Hook and loop fasteners, straps, clamps, snaps, wires, clasps, sleeves, or bands.

Clause 20. The clause of clause 15, wherein the temperature includes a local temperature or an ambient temperature.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIG.s should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

1. A method of preventing ice from forming at a pool cover pump, comprising:
providing a pool cover pump, the pool cover pump comprising:
a housing; and
a pump motor coupled to the housing, wherein the housing comprises:
a plurality of input openings configured to allow water to flow through the plurality of input openings and into the pump motor, and
a heating element located within the housing and configured to heat an area located proximate to the housing, wherein the heating element extends radially from a center of a bottom interior surface of the housing between at least two of the plurality of input openings;
sensing a temperature with a sensor coupled to the housing;
determining the temperature is below a temperature threshold; and
activating the heating element to prevent ice from forming at the area located proximate to the housing.

2. The method of claim 1, further comprising:
determining that the temperature exceeds a second threshold; and
deactivating the heating element.

3. The method of claim 1, wherein the heating element comprises insulated resistive heating wires.

4. (canceled)

5. The method of claim 3, wherein the heating element extends in a spiral pattern from the center of the bottom interior surface of the housing between the at least two of the plurality of input openings.

6. The method of claim 1, wherein the temperature includes a local temperature or an ambient temperature.

7. The method of claim 1, wherein the heating element wraps around a passageway of the pump motor and an output port coupled to the housing.

8. The method of claim 1, wherein the pool cover pump further comprises a discharge line external to the housing and configured to transport water away from the pump motor and an external heating element located proximate to the discharge line.

9. The method of claim 8, wherein the external heating element is coiled, wrapped, entwined, or looped around the discharge line.

10. The method of claim 8, wherein the external heating element is coupled to the discharge line using hook and loop fasteners, straps, clamps, snaps, wires, clasps, sleeves, or bands.

11. An apparatus, comprising:
a housing, wherein the housing comprises a plurality of input openings configured to allow water to flow through the plurality of input openings;
a pump motor located within the housing;
a heating element located within the housing and configured to heat an area located proximate to the housing, wherein the heating element extends in a spiral pattern from a center of the bottom interior surface of the housing between the at least two of the plurality of input openings;
a sensor coupled to the housing;
a controller located within the housing, wherein the controller is configured to:
sense a temperature;
determine the temperature is below a temperature threshold; and
activate the heating element to prevent ice from forming at the area proximate to the housing.

12. The apparatus of claim 11, wherein the controller is further configured to:
determine that the temperature exceeds a second threshold; and
deactivate the heating element.

13. The apparatus of claim 11, wherein the heating element comprises insulated resistive heating wires.

14. The apparatus of claim 13, wherein the heating element extends radially from a center of the bottom interior surface of the housing between at least two of the plurality of input openings.

15. (canceled)

16. The apparatus of claim 11, wherein the temperature includes a local temperature or an ambient temperature.

17. The apparatus of claim 11, wherein the heating element extends to wrap around a passageway of the pump motor and an output port coupled to the housing.

18. The apparatus of claim 11, further comprising:
a discharge line external to the housing and configured to transport water away from the pump motor; and
an external heating element located proximate to the discharge line.

19. The apparatus of claim 18, wherein the external heating element is coiled, wrapped, entwined, or looped around the discharge line.

20. The apparatus of claim 18, wherein the external heating element is coupled to the discharge line using hook and loop fasteners, straps, clamps, snaps, wires, clasps, sleeves, or bands.

21. An apparatus, comprising:
a housing, wherein the housing comprises a plurality of input openings configured to allow water to flow through the plurality of input openings;
a pump motor located within the housing;
a heating element located within the housing and above a bottom interior surface of the housing, the heating element extending between at least two of the plurality of input openings;
a sensor coupled to the housing;
a controller located within the housing, wherein the controller is configured to:
sense a temperature;
determine the temperature is below a temperature threshold; and
activate the heating element to prevent ice from forming at the area located within the passageway of the pump motor.

22. The apparatus of claim 21, wherein the controller is further configured to:
determine that the temperature exceeds a second threshold; and
deactivate the heating element.

23. The apparatus of claim 21, wherein the heating element comprises a heating cable.

24. The apparatus of claim 23, wherein the heating cable encircles a base of the pump motor.

25. The apparatus of claim 23, wherein the heating cable encircles the output port.

26. The apparatus of claim 23, wherein the heating cable comprises insulated resistive heating wires.

27. The apparatus of claim 21, further comprising:
a discharge line external to the housing and configured to transport water away from the pump motor; and
an external heating element located proximate to the discharge line.

28. The apparatus of claim 27, wherein the external heating element is coiled, wrapped, entwined, or looped around the discharge line.

29. The apparatus of claim 27. wherein the external heating element is coupled to the discharge line using hook and loop fasteners, straps, clamps, snaps, wires, clasps. sleeves, or bands.
